(19) United States
(12) Patent Application Publication
(10) Pub. No.: US 2026/0366585 A1
(43) Pub. Date: Nov. 19, 2026

(54) CLAMPING DEVICE FOR A BRAKING SYSTEM WITH INTEGRATED LOCKING MEANS

(71) Applicant: HITACHI ASTEMO FRANCE, Drancy (FR)

(72) Inventor: Philippe BOURLON, DAMMARTIN EN GOELE (FR)

(21) Appl. No.: 19/121,897

(22) PCT Filed: Oct. 9, 2023
(86) PCT No.: PCT/EP2023/077856

§ 371 Date: Apr. 17, 2025

(30) Foreign Application Priority Data
Oct. 26, 2022 (FR) FR2211116

(51) Int. Cl. F16D 65/18; B60T 13/74; F16D 63/00; F16D 121/24; F16D 125/32; F16D 127/02; F16D 127/06

(52) U.S. Cl. CPC F16D 65/18; B60T 13/746; F16D 63/006; F16D 2121/24; F16D 2125/32; F16D 2127/02; F16D 2127/06

(57) ABSTRACT

A clamping device for a braking system intended to cause friction elements to be displaced relative to one another, the clamping device including a first actuator intended to supply a clamping force to the friction elements, and further including a rotor and mechanisms for locking the rotor against rotation. A braking system including this device and a braking method for such a device.

### FIELD OF THE INVENTION

The invention relates to the field of braking systems for vehicles, more particularly of braking systems of the electromechanical and non-self-locking type.

### BACKGROUND

A braking system for a vehicle, in particular a motor vehicle, generally comprises mechanical clamping devices comprising in particular friction elements, such as brake pads. These friction elements are connected to an actuator adapted to move a pair of these friction elements towards two opposite sides of a disc attached to a wheel of the vehicle. This movement enables the friction elements to clamp the disc and thus brake the vehicle by friction of the friction elements against the disc, or move them away in order to stop braking.

In the case of braking systems of the electromechanical type, the mechanical clamping devices comprise at least one electric actuator such as an electric motor provided with a rotating output shaft. Actuation of this electric motor is used to both brake the vehicle while driving but also perform the function of parking brake when the vehicle is kept immobile while stationary, for periods that may be very long. In other words, unlike traditional braking systems where the parking brake consists of a specifically designed system, these braking systems must retain the clamping force exerted by the friction elements against the disc to guarantee an efficient and reliable parking brake. To do this, braking systems of the electromechanical type called “self-locking” systems currently exist, but these systems are complex to implement and are generally expensive. Alternatively, braking systems of the electromechanical type called “non-self-locking” systems exist, for which the electric motor is of the reversible type. In other words, the rotation of the electric motor in a first direction finally induces the clamping of the disc by the friction elements, whereas the actuation of this electric motor in the opposite direction finally induces the unclamping of the disc by the friction elements. To ensure the necessary locking of the friction means when the parking brake function is required, it is known, for these non-self-locking systems, to add a second electric motor, having its own kinetic chain, whose purpose is to clamp the parking brake. However, addition of such a second motor is bulky, thus increasing the space required for the electromagnetic braking device in the vehicle, which conflicts with the current efforts of the automotive industry to try to optimise the smallest space in the vehicles. Apart from its size, such a device is more expensive and complex to implement, both as regards the electrical connections required between its various components and the electronic control unit, as well as regards the control of the two motors by the latter.

### SUMMARY OF THE INVENTION

The invention aims in particular to overcome all the above-mentioned disadvantages by proposing a clamping device for a braking system which is compact, simple to implement and also inexpensive.

Thus, the invention relates to a clamping device for a braking system intended to cause friction elements of said braking system to be displaced relative to one another, the clamping device comprising:
a first actuator of electric motor type comprising a rotor and intended to supply a clamping force to the friction elements by rotation of the rotor,
a system for locking the rotor against rotation, characterised in that the locking system comprises:
first locking means and second locking means of complementary shape, the first locking means being located on the outer surface of the rotor and the second locking means being located opposite the rotor,
a second actuator of electric motor type configured to cause the first locking means and the second locking means to be displaced relative to one another such that they cooperate with each other to lock the rotor against rotation.

Thus, due to the close positioning of the two electrical type actuators (also commonly referred to as “electric motors”) of the device of the invention and the indirect action locking the second actuator on the first actuator, the friction elements can be locked in a position clamping the disc while having a clamping device that is compact and simple to implement. The parking brake function is therefore ensured without the space required in the vehicle being excessively affected since the entire system for locking the rotor against rotation can be located as close as possible to the first electric actuator. In addition, in view of this proximity, the torque required to lock the rotor of the first electric actuator against rotation does not have to be very large, thus allowing the use of a second actuator of smaller size and lower characteristics (power, use current). Thus, the space required for the entire device is reduced.

Due to the complementarity of the shapes of the first locking means and the second locking means, they cooperate when placed in contact with each other, under the action of the relative displacement generated by the second actuator. Cooperation implies a firm and reversible assembly between the first locking means and the second locking means so as to prevent any rotation of the rotor of the first actuator. In addition and when the vehicle needs to move again, the cooperation between the first locking means and the second locking means must be removed. It must be possible to repeat this type of alternation between assembly and disassembly of the first and second locking means reliably over time. To do this, any locking means known by those skilled in the art meeting the above-mentioned criteria can be considered. As non-limiting examples, it could be a cooperation between: a lug and a hole intended to accommodate the lug, two tenons, a tenon and a groove, a tenon and a mortise, teeth, a groove and a tongue, etc.

Advantageously, the first actuator supplies a clamping force to the friction elements by rotation of the rotor in a first direction of rotation, the system locking the rotor against rotation in a second direction of rotation, opposite the first direction of rotation.

To achieve better reactivity when locking the rotor of the first actuator against rotation, the locking system further comprises a rack comprising the second locking means on one of its sides facing the rotor.

So that the device is flexible, the locking system further comprises two stops facing each other, the rack being movably mounted between the two stops.

Advantageously, the locking system further comprises a cam, in contact with the rack, configured to allow a first relative movement of the rack with respect to the rotor of the first actuator, the cam being rotated by the second actuator.

To guarantee the repeatability of the clamping device, the device comprises means for returning the rack configured to allow a second relative movement of the rack with respect to the rotor of the first actuator in a direction opposite to the first relative movement.

Advantageously, the first locking means and the second locking means comprise teeth of complementary shape.

To achieve good reactivity when locking the rotor of the first actuator against rotation, the first locking means are distributed radially around all or part of the circumference of the outer surface of the rotor, preferably around the whole circumference of the outer surface of the rotor.

Advantageously, the first actuator and/or the second actuator are/is a brushless direct current motor.

The invention also relates to a braking system comprising a clamping device according to any one of the preceding variants, an electronic control unit and a box, the first actuator, the second actuator and the electronic control unit being located in the box.

The invention also relates to a braking method for a clamping device according to any one of the preceding variants, the braking method comprising the following steps:
powering up the first actuator, the rotor of the first actuator being movable in rotation so as to supply a clamping force to the friction elements,
reducing the speed of rotation of the rotor,
powering up the second actuator to cause the first locking means and the second locking means to be displaced relative to one another such that they cooperate with each other to lock the rotor against rotation,
powering down the two actuators.

Advantageously, the speed of rotation of the second actuator is between 1 and 2 rpm.

Advantageously, powering up the second actuator rotates the cam until the teeth distributed along the rack come into contact with the teeth distributed radially on the outer surface of the rotor of the first actuator.

### BRIEF DESCRIPTION OF THE FIGURES

The invention will be better understood on reading the following description, given solely by way of example and with reference to the accompanying drawings in which:

FIG. 1 is a diagrammatic view illustrating an embodiment of the device according to the invention,

FIG. 2 is a diagrammatic view illustrating a variant of the embodiment illustrated on FIG. 1,

FIG. 3 is a set of diagrammatic views (FIGS. 3a, 3b and 3b) illustrating the operation of the device according to the embodiment illustrated on FIG. 1.

### DETAILED DESCRIPTION

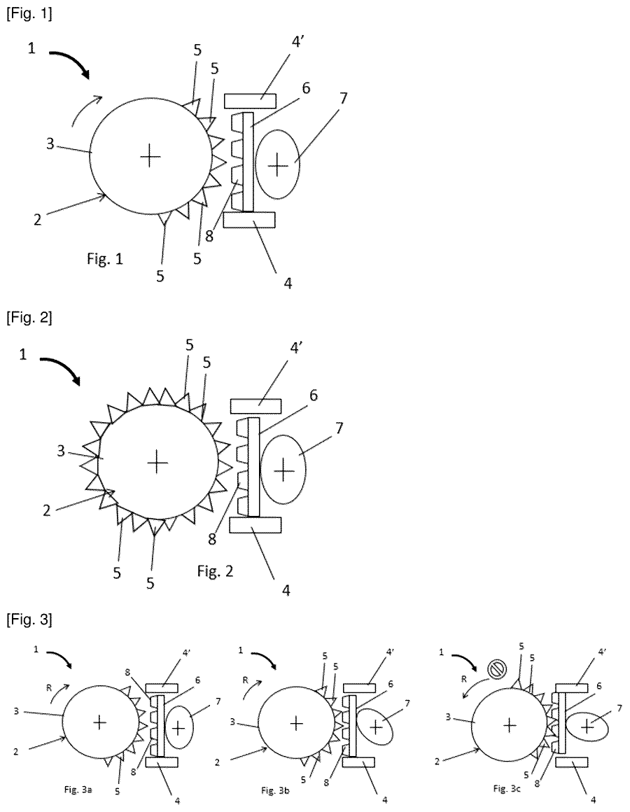

FIGS. 1 to 3c show a clamping device according to a first embodiment (FIGS. 1 and 3a to 3c) and according to a variant (FIG. 2), designated by the general reference 1.

According to this first embodiment and its variant, but also according to embodiments and variants not shown, the clamping device 1 for a braking system intended to cause friction elements of said braking system to be displaced relative to one another, comprises:
a first actuator 2 of brushless direct current type comprising a rotor 3 and intended to supply a clamping force to the friction elements (not shown)
a system for locking the rotor 3 against rotation, comprising:
first locking means and second locking means of complementary shape, the first locking means being located on the outer surface of the rotor and the second locking means being located opposite the rotor,
a second actuator of electric motor type configured to cause the first locking means and the second locking means to be displaced relative to one another such that they cooperate with each other to lock the rotor (3) against rotation

According to this first embodiment and its variant as illustrated on FIGS. 1 to 3c, the first locking means comprise teeth 5 distributed radially on the outer surface of the rotor 3 and the second locking means comprise teeth 8 distributed on one side of a rack 6, said side facing the rotor 3. The shape of the teeth 5 is complementary to that of the teeth 8. The teeth 5 of the first locking means are distributed around a part (FIG. 1) or all (FIG. 2) of the circumference of the rotor 3. Distribution around all of the circumference of the rotor 3 achieves greater reactivity when locking the rotor 3 against rotation since the chances that the teeth 5 and the teeth 8 mesh quickly are greater.

Still according to the first embodiment and its variant, the locking system further comprises:
a rack 6 provided with teeth 8 on one of its sides facing the rotor 3,
two stops 4 and 4′ facing each other, the rack 6 being movably mounted between the two stops 4 and 4′,
a cam 7, in contact with the rack 6, configured to allow a first relative movement of the rack 6 with respect to the rotor 3 of the first actuator 2. The rotation of the cam 7 is generated directly by the second actuator.

The clamping device 1 according to the invention therefore comprises a first brushless direct current actuator 2, known by those skilled in the art, and whose actuation transmits, via a kinetic chain not shown, a clamping force to the friction elements. The latter thus clamp a disc attached to a wheel of the vehicle thereby braking the vehicle. The first actuator 2 comprises a rotor 3 and a stator (not shown). The outer surface rotor 3 is provided, around a part (FIG. 1) or all (FIG. 2) of its circumference, with teeth 5 distributed radially. The shape of these teeth 5 is configured to be complementary to that of the teeth 8 of the rack 6. Thus, when these teeth 5 and 8 mesh, the rotation of the rotor 3 of the first actuator 2 is locked.

The device as illustrated on FIGS. 1 and 3a to 3c will be described in more detail. The entire locking system is intended to lock the rotor 3 of the first actuator 2 against rotation, when stationary parking of the vehicle is required. To do this, it comprises a rack 6 having, on its side facing the rotor 3, the teeth 8 whose shape is complementary to that of the teeth 5 on the rotor 3. The rack 6 is movably mounted between the two stops 4 and 4′ positioned facing each other. In other words, the translation of the rack 6 is limited between the lower stop 4 and the upper stop 4′. The locking means further comprise a cam 7 in contact with said rack 6. More precisely, the cam 7 is in direct and continuous contact with the side of the rack 6 opposite the side facing the rotor 3. Lastly, these locking means comprise a second actuator (not shown) intended to rotate the cam 7, via a kinetic chain not shown. This second actuator is preferably a direct current motor, whose dimension and characteristics (power, use voltage) are less than those of the first actuator 2 of the same type.

We will now describe the operation of the clamping device 1 when stationary parking of the vehicle is required.

In a first configuration (FIG. 3a), following directly a command by the user wanting to actuate the vehicle parking brake, the first actuator 2 is powered up and performs a rotation (whose direction is illustrated by the arrow R) so as to transmit a clamping force to the friction elements. At this stage, the rack 6 is facing the rotor 3 such that the teeth 8 of the rack 6 and the teeth 5 of the rotor 3 do not come into contact and therefore do not interfere with the rotation of the rotor 3. In this first configuration, the rack 6 rests on the lower stop 4.

In a second configuration (FIG. 3b), when the clamping force transmitted due to the action of the first actuator 2 is sufficient or on the point of being sufficient to ensure safe stationary parking of the vehicle, the second actuator is powered up, which rotates the cam 7. This rotation of the cam 7 in turn translates the rack 6 towards the rotor 3 of the first actuator 2. The teeth 8 on the rack 6 and the teeth 5 on the rotor 3, whose shapes are complementary, move closer and come into contact with each other (FIG. 3c), thus fastening the rotor 3 and the rack 6 together. When the first actuator is no longer powered up, it naturally performs a rotation in the opposite direction, under the action of a force resulting from the friction elements. Such a rotation of the rotor 3 in the opposite direction is prevented due to the locking means since, at this stage, the rack fastened to the rotor 3 is displaced until it comes into contact with the upper stop 4′. Thus, the displacements of the rack 6 and, consequently, the rotation of the rotor 3 are prevented, such that the clamping force transmitted to the friction elements is maintained without the need for one of the actuators to be powered continuously.

In a variant not shown, the device advantageously comprises means for returning the rack 6 thus forcing it to return to its initial position (in which the teeth 8 and 5 are away from each other) when the cam no longer exerts sufficient pressure on the rack, which ensures the repeatability of the clamping device.

The braking method implemented by the device according to the invention operates as follows.

When stationary parking of the vehicle is required, the first actuator 2 is powered up so as to supply a clamping force to the friction elements.

Then, the speed of rotation of the rotor 3 of the first actuator 2 is reduced.

The second actuator is powered up to rotate the cam 7 until the teeth 8 on the rack 6 come into contact with the teeth 5 distributed radially on all or part of the circumference of the outer surface of the rotor 3 of the first actuator 2.

Lastly, the two electric motors are powered down.

Advantageously, the clamping device 1 according to one of the embodiments or one of their possible variants is located inside a box, and forms, with said box and an electronic control unit, a braking system according to the invention.

The invention is not limited to the embodiments described and other embodiments will be clearly apparent to those skilled in the art. For example, an embodiment not shown in which the rack is immovably mounted vertically in the device may be considered. Thus, such a device does not require the presence of stops. In another embodiment not shown, the second locking means are distributed on the cam and come into contact with the first locking means when the cam is rotated by the second actuator. Thus, such a device does not require the presence of stops and the rack.

### LIST OF REFERENCES

1: clamping device
2: first actuator of electric motor type
3: rotor
4: lower stop
4′: upper stop
5: teeth of the first locking means
6: rack
7: cam
8: teeth of the second locking means
R: direction of rotation of the rotor 3

1. A clamping device for a braking system intended to cause friction elements of said braking system to be displaced relative to one another, the clamping device comprising:
a first actuator of electric motor type comprising a rotor and intended to supply a clamping force to the friction elements by rotation of the rotor,
a locking system for locking the rotor against rotation, characterised in that the locking system comprises:
a first locking mechanism and a second locking mechanism of complementary shape, the first locking mechanism being located on an outer surface of the rotor and the second locking mechanism being located opposite the rotor,
a second actuator of an electric motor type configured to cause the first locking mechanism and the second locking mechanism to be displaced relative to one another such that they cooperate with each other to lock the rotor against the rotation.

2. The clamping device according to claim 1, wherein the first actuator supplies the clamping force to the friction elements by rotation of the rotor in a first direction of rotation, the locking system locking the rotor against rotation in a second direction of rotation, opposite the first direction of rotation.

3. The clamping device according to claim 2, wherein the locking system further comprises a rack comprising the second locking mechanism on one of its sides facing the rotor.

4. The clamping device according to claim 3, wherein the locking system further comprises two stops facing each other, the rack being movably mounted between the two stops.

5. The clamping device according to claim 4, wherein the locking system further comprises a cam, in contact with the rack, configured to allow a first relative movement of the rack with respect to the rotor of the first actuator, the cam being rotated by the second actuator.

6. The clamping device according to claim 5, comprising means for returning the rack configured to allow a second relative movement of the rack with respect to the rotor of the first actuator in a direction opposite to the first relative movement.

7. The clamping device according to claim 6, wherein the first locking mechanism and the second locking mechanism comprise teeth of complementary shape.

8. The clamping device according to claim 7, wherein the first locking mechanism are distributed radially around all or part of a circumference of the outer surface of the rotor.

9. The clamping device according to claim 8, wherein at least one of the first actuator or the second actuator is a brushless direct current motor.

10. A braking system comprising a clamping device according to claim 1, an electronic control unit and a box, the first actuator, the second actuator and the electronic control unit being located in the box.

11. A braking method for a the clamping device according to claim 1, the braking method comprising steps of:
powering up the first actuator, the rotor of the first actuator being movable in rotation so as to supply a clamping force to the friction elements,
reducing a speed of rotation of the rotor,
powering up the second actuator to cause the first locking mechanism and the second locking mechanism to be displaced relative to one another such that they cooperate with each other to lock the rotor against rotation,
powering down the two actuators.

12. The braking method according to claim 11, wherein the speed of rotation of the second actuator is between 1 and 2 rpm.

13. The braking method according to claim 11, wherein powering up the second actuator rotates a cam until teeth distributed along a rack come into contact with teeth distributed radially on the outer surface of the rotor of the first actuator.

14. The clamping device according to claim 1, wherein the locking system further comprises a rack comprising the second locking mechanism on one of its sides facing the rotor.

15. The clamping device according to claim 3, wherein the locking system further comprises a cam, in contact with the rack, configured to allow a first relative movement of the rack with respect to the rotor of the first actuator, the cam being rotated by the second actuator.

16. The clamping device according to claim 3, wherein the rack is configured to return to an initial position to allow a second relative movement of the rack with respect to the rotor of the first actuator in a direction opposite to the first relative movement.

17. The clamping device according to claim 3, wherein the first locking mechanism and the second locking mechanism comprise teeth of complementary shape.

18. The clamping device according to claim 1, wherein the first locking mechanism are distributed radially around a whole circumference of the outer surface of the rotor.

19. The clamping device according to claim 1, wherein at least one of the first actuator or the second actuator is a brushless direct current motor.
